(19) United States
(12) Patent Application Publication
(10) Pub. No.: US 2005/0070316 A1
(43) Pub. Date: Mar. 31, 2005

(54) Controlled timing during soft hand offs in a wireless system

(75) Inventor: Jung-Tao Liu, Madison, NJ (US)

Correspondence Address: Terry D. Morgan;Williams, Morgan & Amerson, P.C., Suite 1100, 10333 Richmond, Houston, TX, 77042, US

(73) Assignee: Lucent Technologies, Inc.

(21) Appl. No.: 10/674,045

(22) Filed: Sep. 29, 2003

(51) Int. Cl. H04B 15/00

(52) U.S. Cl. 455/502

(57) ABSTRACT

A method for controlling communications between a mobile device and a pair of base stations during a soft hand off mode of operation is provided. Generally, communications between a first base station and a mobile device are synchronized relative to a first timing signal produced by the first base station. When the mobile device is transported to a location that causes the system to hand off communications to a second base station, the mobile device begins communicating with both the first and second base stations, but the communications with both base stations are synchronized relative to the first timing signal. Thereafter, at the completion of the hand off, the mobile device begins communicating solely with the the second base station using a second timing signal delivered by the second base station.

### BACKGROUND OF THE INVENTION

1. Field of the Invention

This invention relates generally to telecommunications, and, more particularly, to wireless communications.

2. Description of the Related Art

In the field of wireless telecommunications, such as cellular telephony, a system typically includes a plurality of Node Bs (e.g., base stations) distributed within an area to be serviced by the system. Various users within the area, fixed or mobile, may then access the system and, thus, other interconnected telecommunications systems, via one or more of the Node Bs. Typically, a UE (e.g., a user) maintains communications with the system as the user passes through an area by communicating with one and then another Node B, as the user moves. The user may communicate with the closest Node B, the Node B with the strongest signal, the Node B with a capacity sufficient to accept communications, etc.

In some wireless communications systems, the UE is synchronized with the Node B to which it is communicating. That is, the UE is assigned a time frame in which it may send voice, data, and/or control signals to the Node B. Transmitting outside the assigned time frame may result in lost signals, particularly where the communications involve high-speed data transfer.

While the UE is ordinarily synchronized with the Node B, the Node Bs are typically not synchronized with one another. Commonly, as the UE transitions from one Node B to another, there is a period of time during which the UE may be communicating with more than one Node B. The process of transitioning the UE from one Node B to another is commonly referred to as soft hand off (SHO). During SHO, both Node Bs may be receiving communications from the UE. However, owing to the timing differences that may exist between the Node Bs, the signals delivered to at least one of the Node Bs may be mistimed, leading to lost data or dropped signals.

In systems that transmit voice, or even data at relatively low speeds, the lost data that may occur during SHO does not significantly impact the quality of the communications session. However, as use of the Internet, e-mail and other data-intensive services have become ubiquitous, wireless communications systems are now attempting to provide some of these same services. These types of services, however, require large amounts of data to be transmitted at relatively high speed. In a system that is intended to transmit large amounts of data at high speed, the lost data can be significant. In fact, the lost data caused by mistimed transmissions can impose substantial limits on the speed at which data can be transmitted, rendering high-speed data communications unworkable in some instances.

The present invention is directed to overcoming, or at least reducing, the effects of one or more of the problems set forth above.

### SUMMARY OF THE INVENTION

In one aspect of the instant invention, a method is provided for controlling a communications system. The method comprises communicating from a first base station to a mobile device using signals that are synchronized with a first synchronizing signal. Communications from the first base station and a second base station to the mobile device are synchronized with the first synchronizing signal during a hand off period. Communications from the second base station to the mobile device are synchronized with a second synchronizing signal after the hand off period.

In another aspect of the instant invention, a method is provided for controlling a mobile device. The method comprises communicating to a first base station using signals synchronized with a first synchronizing signal; communicating to a first base station and a second base station using signals synchronized with the first synchronizing signal during a hand off period; and communicating to the second base station using signals synchronized with a second synchronizing signal after the hand off period.

### BRIEF DESCRIPTION OF THE DRAWINGS

The invention may be understood by reference to the following description taken in conjunction with the accompanying drawings, in which like reference numerals identify like elements, and in which:

FIG. 1A is a block diagram of a communications system, in accordance with one embodiment of the present invention;

FIG. 1B is a stylistic representation of a region in which the communications system of FIG. 1A may be employed;

FIG. 2 depicts a block diagram of one embodiment of a Node B and a UE used in the communications system of FIG. 1;

FIG. 3 is a flow diagram illustrating the interoperation of Node B 1, Node B2 and the UE of FIGS. 1 and 2; and

FIG. 4 is a timing diagram illustrating the interoperation of Node B 1, Node B2 and the UE of FIGS. 1 and 2.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

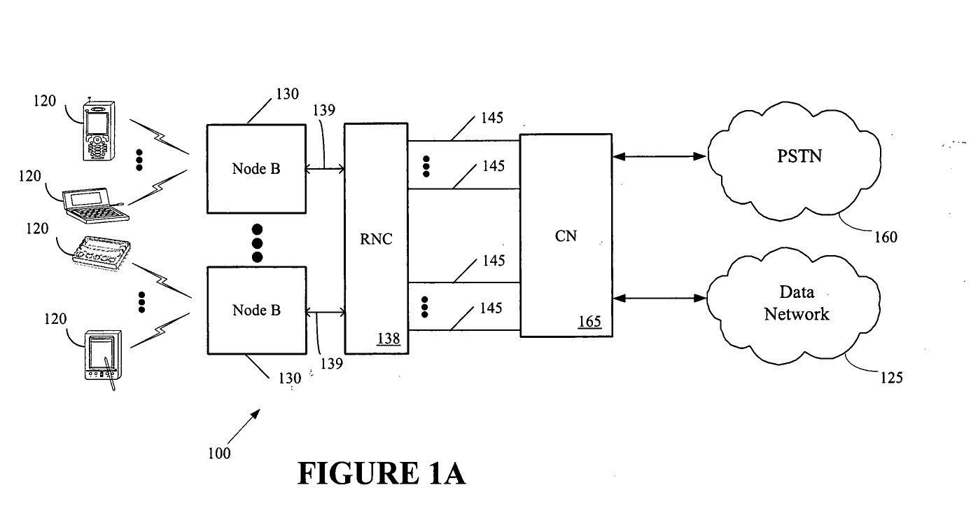

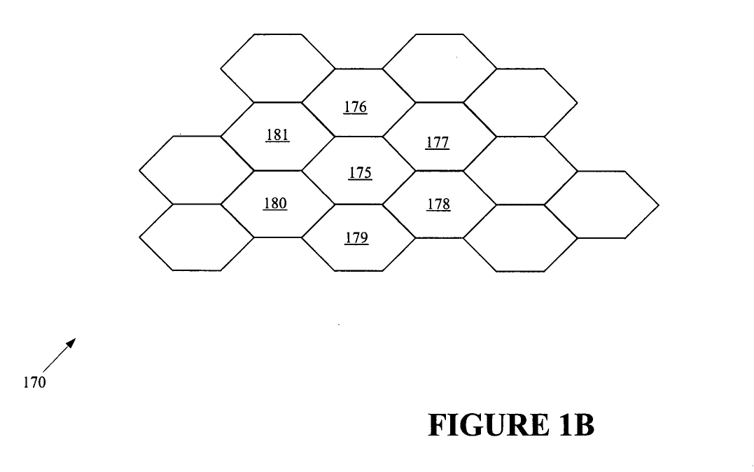

Turning now to the drawings, and specifically referring to FIG. 1A, a communications system 100 is illustrated, in accordance with one embodiment of the present invention. For illustrative purposes, the communications system 100 of FIG. 1A is a Universal Mobile Telephone System (UMTS), although it should be understood that the present invention may be applicable to other systems that support data and/or voice communication. The communications system 100 allows one or more UEs 120 to communicate with a data network 125, such as the Internet, through one or more Node Bs 130. The UE 120 may take the form of any of a variety of devices, including cellular phones, personal digital assistants (PDAs), laptop computers, digital pagers, wireless cards, and any other device capable of accessing the data network 125 through the Node B 130.

In one embodiment, a plurality of the Node Bs 130 may be coupled to a Radio Network Controller (RNC) 138 by one or more connections 139, such as T1/E1 lines or circuits, ATM circuits, cables, optical digital subscriber lines (DSLs), and the like. Although one RNC 138 is illustrated, those skilled in the art will appreciate that a plurality of RNCs 138 may be utilized to interface with a large number of Node Bs 130. Generally, the RNC 138 operates to control and coordinate the Node Bs 130 to which it is connected. The RNC 138 of FIG. 1 generally provides replication, communications, runtime, and system management services. The RNC 138, in the illustrated embodiment handles calling processing functions, such as setting and terminating a call path and is capable of determining a data transmission rate on the forward and/or reverse link for each UE 120 and for each sector supported by each of the Node Bs 130.

The RNC 138 is also responsible for keeping track of timing associated with each of the Node Bs 130, and forwarding that information to each neighboring Node B 130. For example, as is illustrated in FIG. 1B, a region 170 to be serviced by the system 100 is separated into a plurality of regions or cells, each being associated with a separate Node B 130. Typically, each cell has a plurality of adjacent neighboring cells. For example, the cell 175 has six neighboring cells 176-181 such that a UE 120 entering the cell 175 may travel from one of the neighboring cells 176-181. Thus, an SHO may take place when a UE 120 enters the cell 175 from any of the neighboring cells 176-181. As discussed in greater detail below, the Node B 130 associated with the cell 175 may benefit from “knowing” the timing associated with each of its neighboring cells 176-181. The node B 130 associated with the cell 175 may use the timing information associated with its neighboring cells to communicate with the UE 120 using the timing associated with the cell from which the UE 120 is traveling. For example, where the UE 120 is traveling from the cell 176 into the cell 175, the node B 130 associated with the cell 175 may use the timing associated with the cell 176 to communicate with the UE 120 during the SHO. Once the SHO has been completed, the Node B 130 may then send new timing information to the UE 120 so as to transition the UE 120 to the timing associated with the cell 175. In one embodiment of the instant invention, once a Node B is informed of the timing information used by a neighboring Node B, that information is retained for future use.

The RNC 138 is also coupled to a Core Network (CN) 165 via a connection 145, which may take on any of a variety of forms, such as T1/E1 lines or circuits, ATM circuits, cables, optical digital subscriber lines (DSLs), and the like. Generally the CN 165 operates as an interface to a data network 125 and/or to a public telephone system (PSTN) 160. The CN 165 performs a variety of functions and operations, such as user authentication, however, a detailed description of the structure and operation of the CN 165 is not necessary to an understanding and appreciation of the instant invention. Accordingly, to avoid unnecessarily obfuscating the instant invention, further details of the CN 165 are not presented herein.

The data network 125 may be a packet-switched data network, such as a data network according to the Internet Protocol (IP). One version of IP is described in Request for Comments (RFC) 791, entitled “Internet Protocol,” dated September 1981. Other versions of IP, such as IPv6, or other connectionless, packet-switched standards may also be utilized in further embodiments. A version of IPv6 is described in RFC 2460, entitled “Internet Protocol, Version 6 (IPv6) Specification,” dated December 1998. The data network 125 may also include other types of packet-based data networks in further embodiments. Examples of such other packet-based data networks include Asynchronous Transfer Mode (ATM), Frame Relay networks, and the like.

As utilized herein, a “data network” may refer to one or more communication networks, channels, links, or paths, and systems or devices (such as routers) used to route data over such networks, channels, links, or paths.

Thus, those skilled in the art will appreciate that the communications system 100 facilitates communications between the UEs 120 and the data network 125. It should be understood, however, that the configuration of the communications system 100 of FIG. 1A is exemplary in nature, and that fewer or additional components may be employed in other embodiments of the communications system 100 without departing from the spirit and scope of the instant invention.

Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system's memories or registers or other such information storage, transmission or display devices.

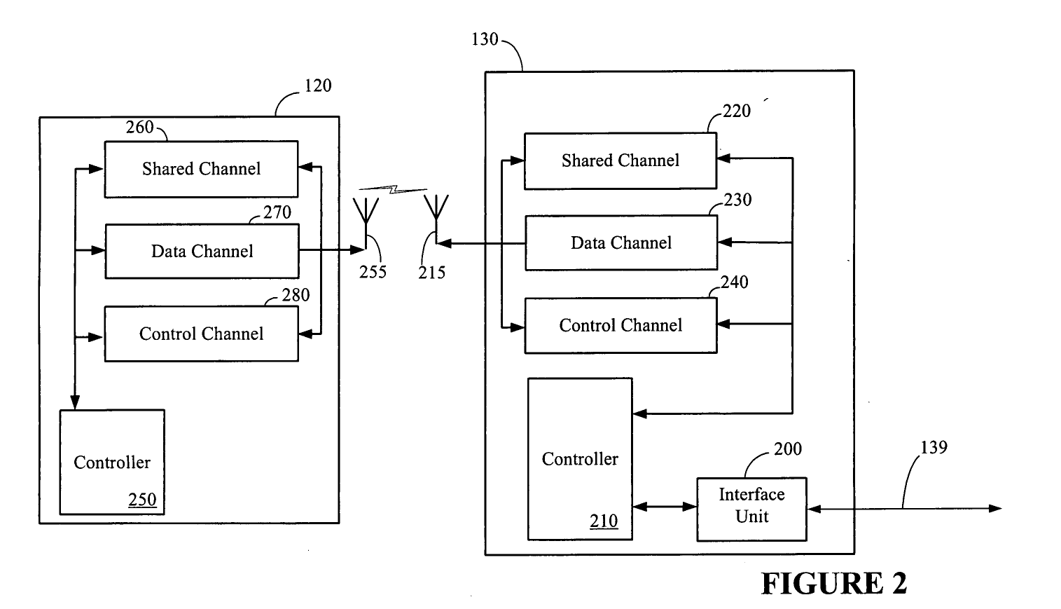

Referring now to FIG. 2, a block diagram of one embodiment of a functional structure associated with an exemplary Node B 130 and UE 120 is shown. The Node B 130 includes an interface unit 200, a controller 210, an antenna 215 and a plurality of channels: a shared channel 220, a data channel 230, and a control channel 240. The interface unit 200, in the illustrated embodiment, controls the flow of information between the Node B 130 and the RNC 138 (see FIG. 1A). The controller 210 generally operates to control both the transmission and reception of data and control signals over the antenna 215 and the plurality of channels 220, 230, 240 and to communicate at least portions of the received information to the RNC 138 via the interface unit 200. For example, one piece of information transmitted from the Node B 130 to the RNC 138 is the timing information used by the Node B 130 to communicate with the UEs 120. Similarly, one type of information communicated to the Node B 130 by the RNC 138 is the timing information used by the neighboring Node Bs 130. For example, since the RNC 138 knows the timing information associated with each of the Node Bs 130 and it knows which of the Node Bs 130 are neighbors to one another, the RNC 138 can provide the timing associated with the cells 176-181 to the Node B 130 associated with the cell 175 (see FIG. 1B). Once the RNC 138 provides this timing information to the Node B 130, regarding one or more of its neighboring Node B's, the Node B 130 stores the information in memory. With the neighboring timing information stored locally in the Node B 130, it may be quickly recalled during subsequent SHO operations involving the same neighboring Node B.

The UE 120 shares certain functional attributes with the Node B 130. For example, the UE 120 includes a controller 250, an antenna 255 and a plurality of channels: a shared channel 260, a data channel 270, and a control channel 280. The controller 250 generally operates to control both the transmission and reception of data and control signals over the antenna 255 and the plurality of channels 260, 270, 280.

Normally, the channels 260, 270, 280 in the UE 120 communicate with the corresponding channels 220, 230, 240 in the Node B 130. Under the operation of the controllers 210, 250, the channels 220, 260; 230, 270; 240, 280 are used to effect a controlled scheduling for communications from the UE 120 to the Node B 130.

Generally, the UE has a first and second status in which it may operate in the network. In the first status, the UE 120 is in contact with a plurality of Node Bs 130, which is sometimes referred to as a soft handoff (“SHO”) or rate controlled mode of operation. In the second status, the “time scheduled” mode of operation, the UE 120 is in contact with only one of the Node Bs 130, which is called the serving Node B. The methodology described herein is a method to control UE transmissions on the uplink when the UE 120 is in the SHO mode of operation. The following description and drawings are presented with reference to the UE 120 entering and leaving the SHO mode of operation, and being in the SHO mode of operation. A more detailed discussion of the “time scheduled” mode of operation can be found in U.S. application Ser. No. 10/442,785, filed May 21, 2003 and assigned to the assignee of the instant application. The contents of U.S. application Ser. No. 10/442,785 is incorporated by reference herein in its entirety.

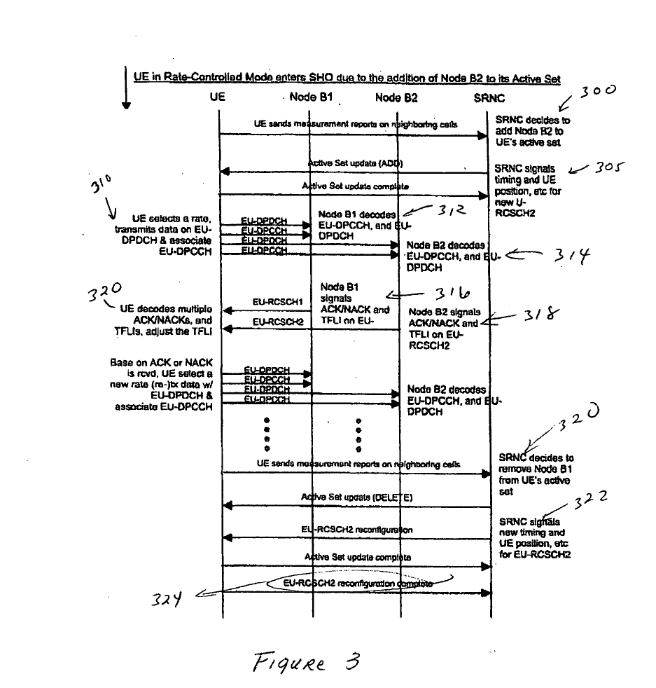

Turning now to FIG. 3, a flow diagram illustrating the interoperation of two base stations, Node B1 and Node B2, and one of the UEs 120 of FIGS. 1 and 2 is shown. In the flow diagram of FIG. 3, the exemplary UE 120 enters and exits the SHO mode of operation, with communications between Node B1, Node B2, the UE 120 and the RNC 138 being illustrated. Initially, the UE 120 is within the cell associated with Node B1 and is approaching or entering the cell associated with the Node B2. The UE 120 provides measurement reports on neighboring cells, such as the cell associated with the Node B2, to the RNC 138. The RNC 138 uses these measurement reports to determine whether the UE 120 should enter the SHO mode of operation in anticipation of turning the UE 120 over to Node B2. If so, the RNC 138 adds Node B2 to an active set associated with the UE 120 (at 300). Generally, the active set is a table or listing that contains the identity of each Node B 130 that may communicate with the UE 120. The RNC 138 sends a signal (at 305) to the UE 120 indicating the now updated active set, as well as specific information regarding a channel that the UE 120 should use to communicate with Node B2. For example, the RNC 138 may indicate timing information regarding a rate-controlled shared channel U-RCSCH2 that will be used by Node B2 to communicate with the UE 120, and any other UEs 120 that are in the SHO mode of operation with both Node B1 and Node B2. The UE 120 is presently communicating with Node B1. An acknowledgment signal indicating that the update is complete is returned to the RNC 138 by the UE 120.

Prior to entering the SHO mode of operation, the UE 120 was in communication with Node B1. Thus, Node B1 had already established a rate-controlled shared channel U-RCSCH1 to allow the Node B1 to communicate with the UE 120. Moreover, Node B1 used U-RCSCH1 to synchronize timing of the UE 120 with Node B1. Thus, to allow for communication between the UE 120 and both Node B 1 and Node B2 at the same time, when Node B2 establishes timing for the channel U-RCSCH2, it set the timing to be substantially identical with that of the channel U-RCSCH1. As discussed above, Node B2 may obtain the timing information used for the channel U-RSCH1 from the RNC 138 the first time that a SHO operation occurs between Node B1 and Node B2. However, on subsequent SHO operations, Node B2 already knows the timing information associated with Node B1 and may recall the timing information from its local memory, rather than waiting to receive the information from the RNC 138.

Those skilled in the art will appreciate that Node B2 may have additional rate-controlled shared channels (e.g., U-RCSCH3, U-RCSCH4, etc.) that may be used by the Node B2 to communicate with UEs 120 that are in the SHO mode of operation with respect to other base stations (e.g., Node B3, Node B4, etc.).

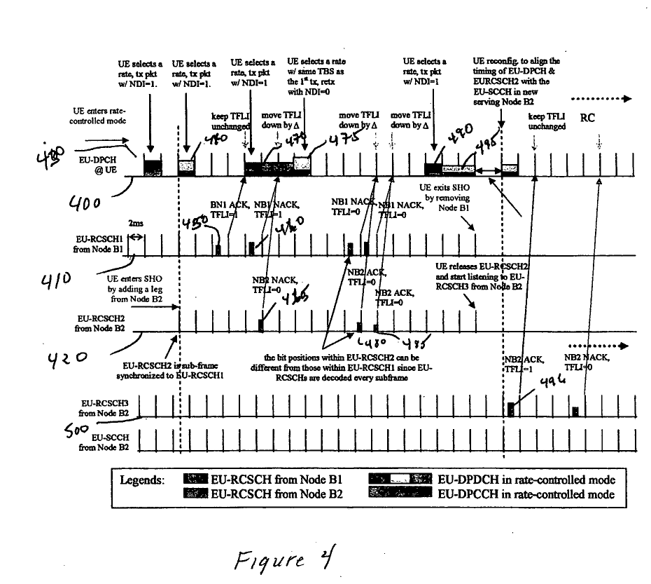

When the UE 120 transmits data and control signals over the data and control channels 270, 280 (at 310) they are received, potentially, by both Node B1 and Node B2. Nodes B1 and B2 decode the channel and control signals (at 312, 314, respectively) and provide acknowledgment and negative acknowledgment signals ACKINACK, as well as other control signals, such as rate limit (TFLI) signals to the UE 120 over the channels EU-RCSCH1 and EU-RCSCH2, respectively. The UE 120 decodes the signals from both Node B1 and Node B2, and uses the information to adjust the TFLI and/or to adjust future transmissions over the data and control channels 270, 280. Exemplary responses by the UE 120 are described in greater detail in conjunction with FIG. 4, below.

This process may be repeated numerous times until the UE 120 exits the SHO mode of operation. The UE 120 sends measurement reports on neighboring cells, such as the cell associated with Node B1 and Node B2, to the RNC 138. The RNC 138 uses these measurement reports to determine whether the UE 120 should exit the SHO mode of operation in anticipation of turning the UE 120 over to Node B2. If so, the RNC 138 removes Node B1 from the active set of the UE 120 (at 320) and sends a signal (at 322) to the UE 120 indicating the now updated active set, as well as specific information regarding a channel that the UE 120 should use to communicate with Node B2. For example, the RNC 138 may indicate new timing information regarding channel U-RCSCH2. Thus, Node B2 may now alter the timing of the UE 120 to synchronize its operation with Node B2 rather than Node B1. An acknowledgment signal indicating that the update is complete is returned to the RNC 138 by the UE 120. Likewise the UE 120 delivers a signal indicating that reconfiguration of EU RCSCH2 is complete (at 324).

While the SHO mode of operation has been described above in the context of two base stations, Node B1 and Node B2, those skilled in the art will appreciate that the SHO mode of operation may involve three or more base stations (e.g., Node B1, Node B2, Node B3 . . . ). Where three or more base stations are involved, the timing associated with the first base station, Node B1, is retained to communicate with all of the other base stations, Node B1, Node B2, . . . .) regardless of the order in which the base stations are removed from the active list of the UE 120. For example, assume a UE 120 is initially communicating with Node B1 but subsequently enters into the SHO mode of operation with Node B2 and then Node B3, such that all three base stations are in the UE 120 active set. If Node B1 is removed from the active set, leaving Nodes B2 and B3 in the active set, the UE 120 nonetheless continues to communicate with Nodes B2 and B3 using the timing information associated with Node B1. As long as the UE 120 remains in the SHO mode of operation, it will continue to use the timing information associated with Node B1 until only one base station remains in its active set, at which time the UE 120 will resynchronize with the timing information associated with its now lone base station.

Turning now to FIG. 4, a timing diagram illustrating exemplary scheduling and transmission of data between the UE 120 and Node B1 and Node B2 is illustrated. The top line 400 of timing information illustrates the timing of signals delivered by the UE 120 over its data and control channels 270, 280 during the SHO mode of operation. The middle line 410 of timing information illustrates the timing of signals delivered by Node B1 on the shared channel RCSCH1. The bottom line 420 of timing information illustrates the timing of signals delivered by Node B2 on the shared channel RCSCH2. The top, bottom and middle lines 400, 410, 420 are related by their use of the same relative time scale. It should be noted that, as discussed above, RCSCH1 and RCSCH2 are synchronized during the SHO mode of operation.

The process of transmitting information in the SHO mode of operation begins with the UE 120 transmitting a first, new packet of data 430 on the data channel. Thereafter, prior to receiving any acknowledgement signals from either Node B1 or Node B2, the UE 120 transmits a second, new packet of data 440 on the data channel. Node B1 subsequently provides an acknowledgment signal 450 on its shared channel RCSCH1, indicating that the data packet 430 was properly received at Node B1, but no signal is received from the Node B2 over the shared channel RCSCH2. Nevertheless, since the data packet 430 was properly received by at least one of the base stations (i.e., Node B1), as indicated by the acknowledgment signal 450, the UE 120 releases the packet of data and does not attempt to retransmit it.

Shortly thereafter, negative acknowledgement signals (NACKs) are transmitted by Node B1 and Node B2 on their respective shared channels RCSCH1 and RCSCH2, indicating that the second packet of data 440 was not received properly by either Node B1 or Node B2. Since the data packet 440 was not properly received by at least one of the base stations (e.g., Node B1 or Node B2), as indicated by NACK signals 460, 465, the UE 120 does not release the packet of data, but rather, schedules the data packet 440 for retransmission. The UE 120 is, however, in the process of transmitting a third, new packet of data 470, and thus, cannot immediately retransmit the second data packet 440. Once the UE 120 complete transmission of the third data packet 470, it begins to retransmit the second data packet, as indicated at 475. During subsequent time intervals, at least one of the base stations (e.g., Node B2) provides an acknowledgment signal, indicating that the third and retransmitted second data packets were properly received.

Later, the UE 120 transmits a new, fourth data packet 490, and then begins to transmit a new, fifth data packet 495, but is interrupted by the UE moving out of the SHO mode of operation and into the time scheduled mode of operation where it communicates only with Node B2. As discussed above with respect to FIG. 3, the RNC 138 removes Node B1 from the active set of the UE 120 (at 320) and sends a signal (at 322) to the UE 120 indicating the now updated active set, as well as specific information regarding a channel that the UE 120 should use to communicate with Node B2. For example, the RNC 138 may indicate new timing information regarding channel RCSCH3. Thus, the timing of the UE 120 is synchronized with Node B2 rather than Node B1. Thereafter, Node B2 delivers an ACK signal 496 to the UE 120 using the “new” shared channel RCSCH3, indicating that the fourth data packet 490 was properly received by the Node B2. Since Node B1 is no longer in the active set of the UE 120, it does not provide an ACK/NACK signal regarding the data packet 490.

Once synchronization of the UE 120 with the timing of Node B2 is complete, the UE 120 continues and completes transmission of the partially completed data packet 495. The Node B2 subsequently provides an ACKINACK signal 497 over shared channel RCSCH3 to indicate to the UE 120 whether the packet has been properly received or should be retransmitted.

Those skilled in the art will appreciate that the various system layers, routines, or modules illustrated in the various embodiments herein may be executable control units (such as the controllers 210, 250 (see FIG. 2)). The controllers 210, 250 may include a microprocessor, a microcontroller, a digital signal processor, a processor card (including one or more microprocessors or controllers), or other control or computing devices. The storage devices referred to in this discussion may include one or more machine-readable storage media for storing data and instructions. The storage media may include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy, removable disks; other magnetic media including tape; and optical media such as compact disks (CDs) or digital video disks (DVDs). Instructions that make up the various software layers, routines, or modules in the various systems may be stored in respective storage devices. The instructions when executed by the controllers 210, 250 cause the corresponding system to perform programmed acts.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. Consequently, the method, system and portions thereof and of the described method and system may be implemented in different locations, such as the wireless unit, the base station, a base station controller and/or mobile switching center. Moreover, processing circuitry required to implement and use the described system may be implemented in application specific integrated circuits, software-driven processing circuitry, firmware, programmable logic devices, hardware, discrete components or arrangements of the above components as would be understood by one of ordinary skill in the art with the benefit of this disclosure. It is therefore evident that the particular embodiments disclosed above may be altered or modified and all such variations are considered within the scope and spirit of the invention. Accordingly, the protection sought herein is as set forth in the claims below.

1. A method for controlling a communications system, comprising:
communicating using signals synchronized with a first synchronizing signal;
communicating using signals synchronized with the first synchronizing signal during a hand off period; and
communicating using signals synchronized with a second synchronizing signal after the hand off period.

2. A method, as set forth in claim 1, wherein the first synchronizing signal is delivered from a first base station to a mobile device.

3. A method, as set forth in claim 1, wherein the second synchronizing signal is delivered from a second base station to a mobile device.

4. A method, as set forth in claim 1, further comprising receiving signals reflecting parameters of communication between a mobile device and a second base station.

5. A method, as set forth in claim 4, wherein the hand off period is initiated in response to the parameters of communication between the mobile device and the second base station.

6. A method, as set forth in claim 4, wherein the second base station is added to an active set associated with the mobile device, wherein each base station in the active set is permitted to communicate with the mobile device.

7. A method, as set forth in claim 6, further comprising communicating the active set to the mobile device.

8. A method, as set forth in claim 1, further comprising receiving signals reflecting parameters of communication between a mobile device and a first base station.

9. A method, as set forth in claim 8, wherein the hand off period is terminated in response to the parameters of communication between the mobile device and the first base station.

10. A method, as set forth in claim 9, wherein the first base station is removed from an active set associated with the mobile device, wherein each base station in the active set is permitted to communicate with the mobile device.

11. A method, as set forth in claim 10, further comprising communicating the active set to the mobile device.

12. A method, as set forth in claim 1, wherein communicating using signals synchronized with the first synchronizing signal during the hand off period further comprises communicating from a first base station, a second base station and a third base station to a mobile device using signals synchronized with the first synchronizing signal during a hand off period.

13. A method, as set forth in claim 12, wherein communicating from the second base station to the mobile device using signals synchronized with a second synchronizing signal after the hand off period further comprises communicating from the second base station to the mobile device using signals synchronized with the second synchronizing signal in response to communications with both the first and third base stations being ended.

14. A method, as set forth in claim 13, wherein communicating from the second base station to the mobile device using signals synchronized with the second synchronizing signal in response to communications with both the first and third base stations being ended further comprises communicating from the second base station to the mobile device using signals synchronized with the second synchronizing signal in response to communications with the first base station and then the third base station being ended.

15. A method, as set forth in claim 13, wherein communicating from the second base station to the mobile device using signals synchronized with the second synchronizing signal in response to communications with both the first and third base stations being ended further comprises communicating from the second base station to the mobile device using signals synchronized with the second synchronizing signal in response to communications with the third base station and then the first base station being ended.

16. A method, as set forth in claim 1, further comprising a second base station retaining in memory the first synchronizing signal.

17. A method for controlling a mobile device, comprising:
communicating using signals synchronized with a first synchronizing signal;
communicating using signals synchronized with the first synchronizing signal during a hand off period; and
communicating using signals synchronized with a second synchronizing signal after the hand off period.

18. A method, as set forth in claim 17, wherein the first synchronizing signal is received by a mobile device from a first base station.

19. A method, as set forth in claim 17, wherein the second synchronizing signal is received by a mobile device from a second base station.

20. A method, as set forth in claim 17, further comprising delivering signals reflecting parameters of communication between a mobile device and a second base station.

21. A method, as set forth in claim 20, wherein the hand off period is initiated in response to the parameters of communication between the mobile device and the second base station and the mobile device receives a signal adding the second base station to an active set associated with the mobile device, wherein each base station in the active set is permitted to communicate with the mobile device.

22. A method, as set forth in claim 17, further comprising delivering signals reflecting parameters of communication between a mobile device and a first base station.

23. A method, as set forth in claim 22, wherein the hand off period is terminated in response to the parameters of communication between the mobile device and the first base station and the mobile device receives a signal removing the first base station from an active set associated with the mobile device, wherein each base station in the active set is permitted to communicate with the mobile device.

24. A method, as set forth in claim 17, wherein communicating to using signals synchronized with the first synchronizing signal during the hand off period further comprises communicating to a first base station, a second base station and a third base station using signals synchronized with the first synchronizing signal during a hand off period.

25. A method, as set forth in claim 24, wherein communicating to the second base station using signals synchronized with the second synchronizing signal after the hand off period further comprises communicating to the second base station using signals synchronized with the second synchronizing signal in response to communications with both the first and third base stations being ended.

26. A method, as set forth in claim 25, wherein communicating to the second base station using signals synchronized with the second synchronizing signal in response to communications with both the first and third base stations being ended further comprises communicating to the second base station using signals synchronized with the second synchronizing signal in response to communications with the first base station and then the third base station being ended.

27. A method, as set forth in claim 24, wherein communicating to the second base station using signals synchronized with the second synchronizing signal in response to communications with both the first and third base stations being ended further comprises communicating to the second base station using signals synchronized with the second synchronizing signal in response to communications with the third base station and then the first base station being ended.
